(19) United States
(12) Patent Application Publication
(10) Pub. No.: US 2025/0335169 A1
(43) Pub. Date: Oct. 30, 2025

(54) INTEGRATION DEVELOPMENT AND DEPLOYMENT FRAMEWORK

(71) Applicant: Dell Products L.P., Round Rock, TX (US)

(72) Inventors: Madhusudhana Reddy Chilipi, Leander, TX (US); Anusha Shetty, Bangalore (IN); Ananth Nagaraju, Siddipet (IN); Karthik K, Bangalore (IN); Hung Dinh, Austin, TX (US); Pushpa Kumar Marlapalli, Leander, TX (US); Ravishankar Alla, Shrewsbury, MA (US); Tousif Mohammed, Bangalore (IN); Vishnu Prabhu Sundarrajan, Bangalore (IN); Ganesh Badi, Vasanthawada (IN); Bhargavi Sharvani Davala, Puttur (IN); Rohit Nayak, Bangalore (IN); Zishnu Das, Bangalore (IN)

(21) Appl. No.: 18/647,005

(22) Filed: Apr. 26, 2024

(51) Int. Cl. G06F 8/60; G06F 8/30

(52) U.S. Cl. CPC G06F 8/60; G06F 8/30

(57) ABSTRACT

A method comprises receiving a request for integration of a plurality of computing instances, wherein the request comprises a plurality of features for the integration, and implementing a plurality of services based at least in part on the plurality of features, wherein at least one service of the plurality of services comprises at least one code generation service. Code for the integration is generated using the at least one code generation service. The generated code for the integration is pushed to at least one development and information technology operations platform.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to a framework for development and deployment of integrations.

### BACKGROUND

Each enterprise application team faces unique data integration requirements for seamless data exchange between applications. Currently, integration projects require extensive programming efforts to develop code, and to create deployment and configuration files. In addition, conventional approaches waste compute and developer resources on troubleshooting code errors and working on non-functional requirements in connection with the integrations.

### SUMMARY

Embodiments provide an integration development and deployment framework in an information processing system.

For example, in one embodiment, a method comprises receiving a request for integration of a plurality of computing instances, wherein the request comprises a plurality of features for the integration, and implementing a plurality of services based at least in part on the plurality of features, wherein at least one service of the plurality of services comprises at least one code generation service. Code for the integration is generated using the at least one code generation service. The generated code for the integration is pushed to at least one development and information technology operations platform.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with an integration development and deployment framework in an illustrative embodiment.

FIG. 2 depicts an operational flow for inputting features for application integration in an illustrative embodiment.

FIG. 3 depicts an operational architecture of the integration development and deployment framework in an illustrative embodiment.

FIG. 4 depicts an operational flow for integration in an illustrative embodiment.

FIG. 5 depicts a process flow for computing instance integration in connection with selection of a point-to-point (P2P) pattern in an illustrative embodiment.

FIG. 6 depicts a user interface for specifying details for an enterprise integration services (EIS) message filter in an illustrative embodiment.

FIG. 7 illustrates a portion of integration code generated for an EIS filter in an illustrative embodiment.

FIG. 8 illustrates a user interface for inputting recipient routing details in an illustrative embodiment.

FIG. 9 illustrates a portion of integration code generated for recipient routing in an illustrative embodiment.

FIG. 10 illustrates a user interface for inputting webservice outbound gateway details in an illustrative embodiment.

FIG. 11 illustrates a portion of integration code generated for a webservice outbound gateway in an illustrative embodiment.

FIG. 12 illustrates a generated project structure that is pushed to a development and information technology operations (DevOps) platform in an illustrative embodiment.

FIG. 13 illustrates generated externalized application properties that are pushed to a DevOps platform in an illustrative embodiment.

FIG. 14 illustrates a generated deployment artifact cloud platform as a service (PaaS) manifest in an illustrative embodiment.

FIG. 15 is a block diagram of a P2P without routing message-oriented-middleware (MOM) messaging integration pattern (MIP) in an illustrative embodiment.

FIG. 16 is a block diagram of a P2P without routing and with load balancing MOM MIP in an illustrative embodiment.

FIG. 17 is a block diagram of a many-to-one P2P without routing MOM MIP in an illustrative embodiment.

FIG. 18 is a block diagram of a P2P with routing MOM MIP in an illustrative embodiment.

FIG. 19 is a block diagram of a fan-out MOM MIP in an illustrative embodiment.

FIG. 20 is a block diagram of a publisher/subscriber MOM MIP in an illustrative embodiment.

FIG. 21 depicts a process for development and deployment of integrations according to an illustrative embodiment.

FIGS. 22 and 23 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

As used herein, “application programming interface (API)” refers to a set of subroutine definitions, protocols, and/or tools for building software. Generally, an API defines communication between software components. APIs permit software applications to be written so as to be consistent with an operating environment or website. In a non-limiting example, APIs enable software components to communicate with each other using designated definitions and protocols.

As used herein, the term “middleware” is to be broadly construed to refer to software that links different applications. Some examples of middleware are products that establish connections between web servers and database systems and connections between message producers and consumers. As used herein, the term “integration” or “integrations” is to be broadly construed to refer to middleware that is classified based on domains. Some examples of integrations are cloud integration, business-to-business (B2B) integration, application integration (A2A) and data integration products. Cloud integration products integrate with and between cloud services, cloud-based applications, private clouds, trade hubs. Cloud integration products may use, for example, web services and B2B communication strategies. B2B integration products integrate customer, provider and partner interfaces with various data resources and enterprise managed applications. A2A products integrate enterprise managed cloud-based and/or remote system applications with each other. Data integration products integrate enterprise data resources, such as, for example, databases and files, over enterprise and operational intelligence systems. Some non-limiting examples of middleware comprise MOM or message queue (MQ) products, autonomous integration cloud (AIC) products, service-oriented architecture (SOA) products and B2B products.

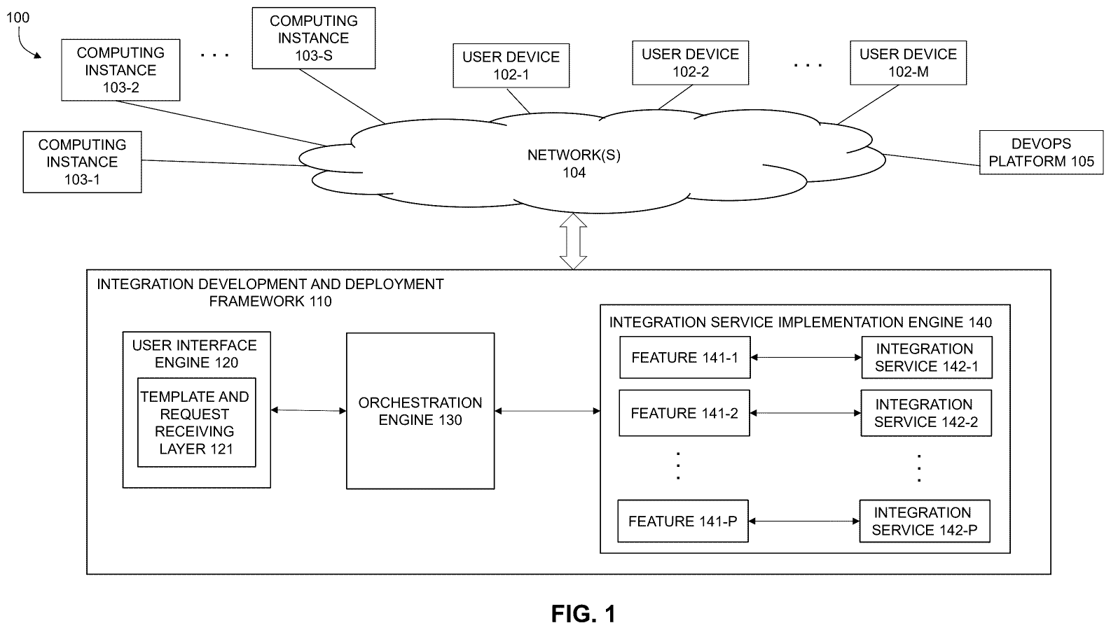

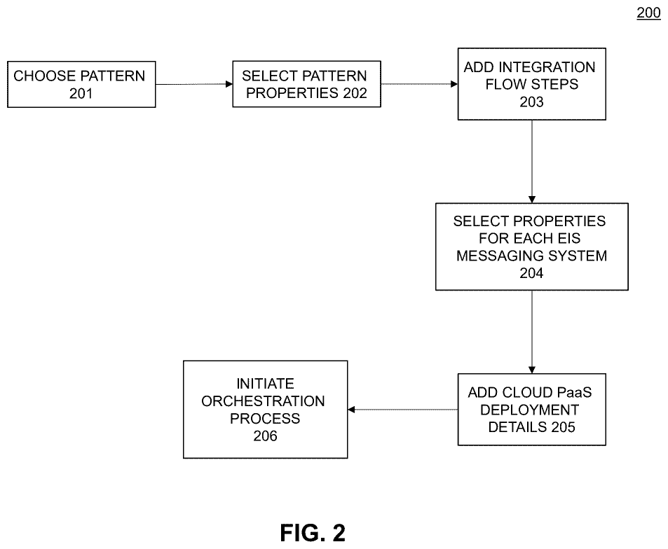

FIG. 1 shows an information processing system 100 configured in accordance with an illustrative embodiment. The information processing system 100 comprises user devices 102-1, 102-2, . . . 102-M (collectively “user devices 102”), computing instances 103-1, 103-2, . . . 103-S (collectively “computing instances 103”) and at least one DevOps platform 105. In illustrative embodiments, the computing instances 103 comprise, for example, applications, microservices, platforms (e.g., cloud platforms), databases, virtual machines (VMs), middleware and devices (e.g., servers, host devices or other processing devices). Microservices comprise, for example, collections of loosely coupled, fine-grained and parallelized services implementing lightweight protocols. The computing instances 103 may correspond to a variety of designs, architectures and protocols, such as, for example, Point-to-Point (P2P), webservice, batch, request/reply, publisher/subscriber, extensible markup language (XML), JavaScript Object Notation (JSON), representational state transfer (REST), simple object access protocol (SOAP) and messaging integration patterns (MIP), and input data flows through different interfaces via, for example, file transfer protocol (FTP) servers and different MOM platforms.

The computing instances 103 can further include data sources such as, but not necessarily limited to, inventory databases (e.g., inventoried data and metadata associated with one or more integrated computing instances 103, channel poller(s), change tracking service data (e.g., Git properties and Git pipeline data), monitoring service databases (e.g., Actmon databases) and application support service data (e.g., cloud service, for example, Pivotal Cloud Foundry (PCF) information). In one or more embodiments, the data may be in the form of notifications and/or alerts sent to users (e.g., via user devices 102) in response to one or more issues (e.g., failures, anticipated failures) with the integrated computing instances 103. The computing instances can also include cloud deployment services (e.g., PCF), cloud-based website and application performance tracking services, workflow orchestration services and middleware sources, including, for example, MOM providers. Some non-limiting examples of MOM providers are IBM© MQ (International Business Machines Corporation, Armonk, NY), RabbitMQ® (RMQ) (Pivotal Software, Inc., San Francisco, CA), Apache™ ActiveMQ® and Apache™ Kafka® (Apache Software Foundation, Wakefield, MA). The MOM providers include architectures with, for example, APIs and administrative tools to route and deliver messages. In an embodiment, the MOM providers respectively run on different operating systems and/or platforms or different implementations of the same operating system and/or platforms. For example, the MOM providers are of different types, and require different functionality or implementations of connectivity/messaging protocols, such as, for example, machine-to-machine (M2M) messaging protocols. In a non-limiting embodiment, M2M protocols can include, but are not necessarily limited to, Message Queuing Telemetry Transport (MQTT), constrained application protocol (CoAP), and/or Open Mobile Alliance (OMA) lightweight machine to machine (LWM2M).

In illustrative embodiments, the DevOps platform 105 comprises a platform for the development, securing, and operation of software. An example of a DevOps platform is GitLab®. The user devices 102, computing instances 103 and DevOps platform 105 communicate over a network 104 with an integration development and deployment framework 110.

The user devices 102, devices of the computing instances 103 and of the DevOps platform 105 can comprise, for example, Internet of Things (IoT) devices, desktop, laptop or tablet computers, mobile telephones, or other types of processing devices capable of communicating with the integration development and deployment framework 110 over the network 104. Such devices are examples of what are more generally referred to herein as “processing devices.” Some of these processing devices are also generally referred to herein as “computers.” The user devices 102 may also or alternately comprise virtualized computing resources, such as virtual machines (VMs), containers, etc. The user devices 102, devices of the computing instances 103 and of the DevOps platform 105 in some embodiments comprise respective computers associated with a particular company, organization or other enterprise. The variable M and other similar index variables herein such as K, L, S and P are assumed to be arbitrary positive integers greater than or equal to two.

The terms “client” or “user” herein are intended to be broadly construed so as to encompass numerous arrangements of human, hardware, software or firmware entities, as well as combinations of such entities. Testing services may be provided for users utilizing one or more machine learning models, although it is to be appreciated that other types of infrastructure arrangements could be used. At least a portion of the available services and functionalities provided by the integration development and deployment framework 110 in some embodiments may be provided under Function-as-a-Service (“FaaS”), Containers-as-a-Service (“CaaS”), Platform-as-a-Service (“PaaS”) and/or Integration-as-a-Service (INaaS) models, including cloud-based FaaS, CaaS, PaaS and INaaS environments.

Although not explicitly shown in FIG. 1, one or more input-output devices such as keyboards, displays or other types of input-output devices may be used to support one or more user interfaces to the integration development and deployment framework 110, as well as to support communication between the integration development and deployment framework 110 and connected devices (e.g., user devices 102, devices of the computing instances 103 and of the DevOps platform 105) and/or other related systems and devices not explicitly shown.

In some embodiments, the user devices 102, devices of the computing instances 103 and of the DevOps platform 105 are assumed to be associated with repair technicians, system administrators, information technology (IT) managers, software developers, release management personnel or other authorized personnel configured to access and utilize the integration development and deployment framework 110.

The integration development and deployment framework 110 in the present embodiment is assumed to be accessible to the user devices 102, devices of the computing instances 103 and of the DevOps platform 105 over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The integration development and deployment framework 110, on behalf of respective infrastructure tenants each corresponding to one or more users associated with respective ones of the user devices 102 provides a platform for the development and deployment of integrations. The integration development and deployment framework 110 increases the efficiency and speed for implementation of integration projects when compared with conventional approaches. Advantageously, the integration development and deployment framework 110 generates integration code for enterprise integration patterns (EIPs) and message integration patterns (MIPs), making development faster and easier than with current techniques. The integration development and deployment framework 110 provides a unified development environment that supports various EIPs and MIPs including those patterns corresponding to message construction, content-based routing, and messaging endpoints. The integration development and deployment framework 110 facilitates management of a wide range of integration scenarios, enabling quick compilation, building and deployment of solutions, while also allowing for rapid iterations and adaptability.

Referring to FIG. 1, the integration development and deployment framework 110 includes a user interface engine 120, an orchestration engine 130, and an integration service implementation engine 140. The user interface engine 120 comprises a template and request receiving layer 121. The integration service implementation engine 140 analyzes a plurality of features 141-1, 141-2, . . . 141-P (collectively “features 141”) to implement integration services 142-1, 142-2, . . . 142-P (collectively “integration services 142”).

The user interface engine 120, more particularly, the template and request receiving layer 121, provides a portal through which users (e.g., via user devices 102) can access a plurality of templates for a user to specify features for an integration. The portal can include, for example, a gateway that can be accessed via a website or other online location for users to interface with the integration development and deployment framework 110 and enter a request for integration. The portal includes multiple templates through which users may specify features for the integration. The features include, but are not necessarily limited to, enterprise integration services (EIS) messaging system features such as, but not necessarily limited to, filters, routers, channels, endpoints, and messaging connectors (e.g., to connect message channels). A message filter can be used to eliminate certain types of messages and/or content from a channel based on a given criteria. For example, if a message matches a criteria specified by the message filter, the message from an input channel is routed to an output channel. If message content does not match the criteria, the message may be discarded.

In illustrative embodiments, referring for example to the operational flow 200 in FIG. 1, a user accesses a template where the user can select an MIP (e.g., P2P, Pub-Sub, fan-out, etc.) (choose pattern 201) and select properties of the MIP (step 202) (e.g., with or without routing, with or without load balancing, many-to-one, network connections, etc.).

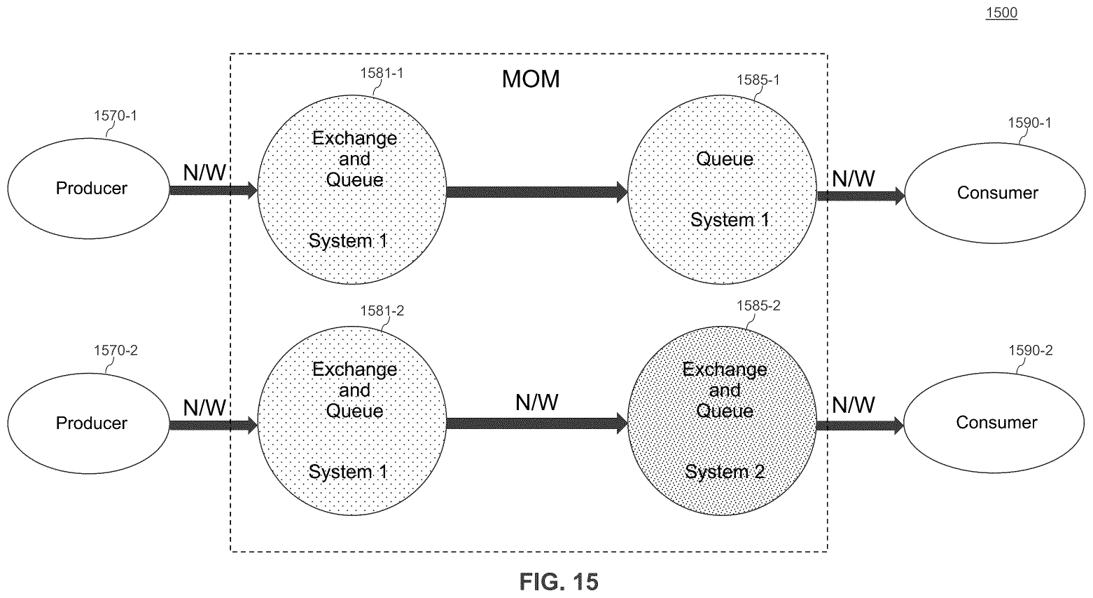

Referring to FIGS. 15-20, possible MOM MIPs comprise, for example, a P2P without routing MOM MIP 1500, a P2P without routing and with load balancing MOM MIP 1600, a many-to-one P2P without routing MOM MIP 1700, a P2P with routing MOM MIP 1800, a fan-out MOM MIP 1900 and a publisher/subscriber MOM MIP 2000. The MIPs 1500-2000 indicate network connections (N/W) between elements having different IP addresses.

The MOM MIP 1500 in FIG. 15 is an example of a P2P without routing MOM MIP 1500. In FIG. 15, producers 1570-1 and 1570-2 are respectively connected to messaging exchanges and queues (exchange/queue 1581-1 and exchange/queue 1581-2), which transmit messages to messaging queue 1585-1 and messaging exchange/queue 1585-2, respectively, for consumption by consumers 1590-1 and 1590-2, respectively. The messaging queue 1585-1 is connected to exchange/queue 1581-1 without a network since they are on the same server. FIG. 15 indicates that exchange/queue 1581-1, exchange/queue 1581-2 and messaging queue 1585-1 correspond to the same MOM platform (System 1). The messaging exchange/queue 1585-2 is on a different server associated with a different MOM platform (System 2), and is connected to the exchange/queue 1581-2 via a network. In this and other instances described herein, an exchange and/or queue on a different server from other exchanges and/or queues may indicate that a consumer corresponding to the exchange and/or queue on the different server is using a different MOM provider than other consumers. For example, in the case of FIG. 15, consumer 1590-2 may be using a different MOM provider than consumer 1590-1. The producers 1570-1 and 1570-2 are respectively connected to exchange/queue 1581-1 and exchange/queue 1581-2 via one or more networks, and messaging queue 1585-1 and messaging exchange/queue 1585-2 are respectively connected to consumers 1590-1 and 1590-2 via one or more networks.

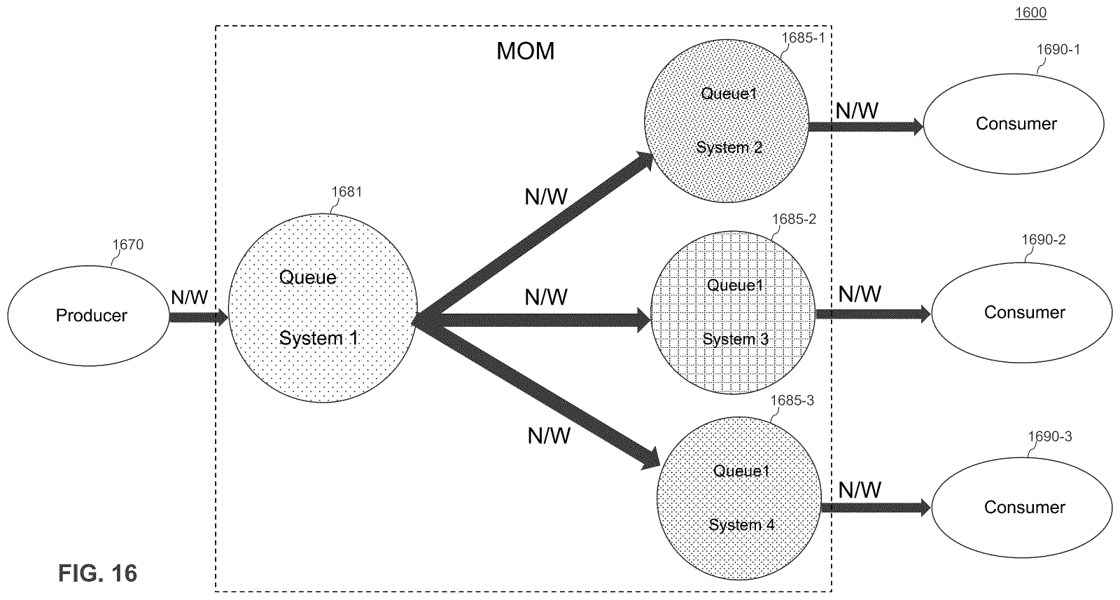

The MOM MIP 1600 in FIG. 16 is an example of a P2P with load balancing and without routing MOM MIP 1600. In FIG. 16, a producer 1670 is connected to a messaging queue 1681 of System 1, which transmits messages to messaging queues 1685-1, 1685-2 and 1685-3 of Systems 2, 3 and 4, respectively, for consumption by consumers 1690-1, 1690-2 and 1690-3. In the FIG. 16 embodiment, in a load balancing arrangement, the queue 1681 sends each message in the queue to the next queue (queue1, queue2 or queue3 1685-1, 1685-2 or 1685-3), in sequence. In this round-robin distribution, each consumer 1690-1, 1690-2 and 1690-3 receives approximately the same number of messages. For example, a first message will be transmitted to a first consumer 1690-1, a second message to a second consumer 1690-2, a third message to a third consumer 1690-3, a fourth message to the first consumer 1690-1 and so on.

Queue1, queue2 and queue3 1685-1, 1685-2 and 1685-3 are each on different servers associated with different MOM platforms from each other (System 2, System 3 and System 4), and from queue 1681. Each of queue1, queue2 and queue3 1685-1, 1685-2 and 1685-3 are connected to queue 1681 via a network. The producer 1670 is connected to queue 1681 via a network, and the queues 1685-1, 1685-2 and 1685-3 are connected to consumers 1690-1, 1690-2 and 1690-3 via one or more networks.

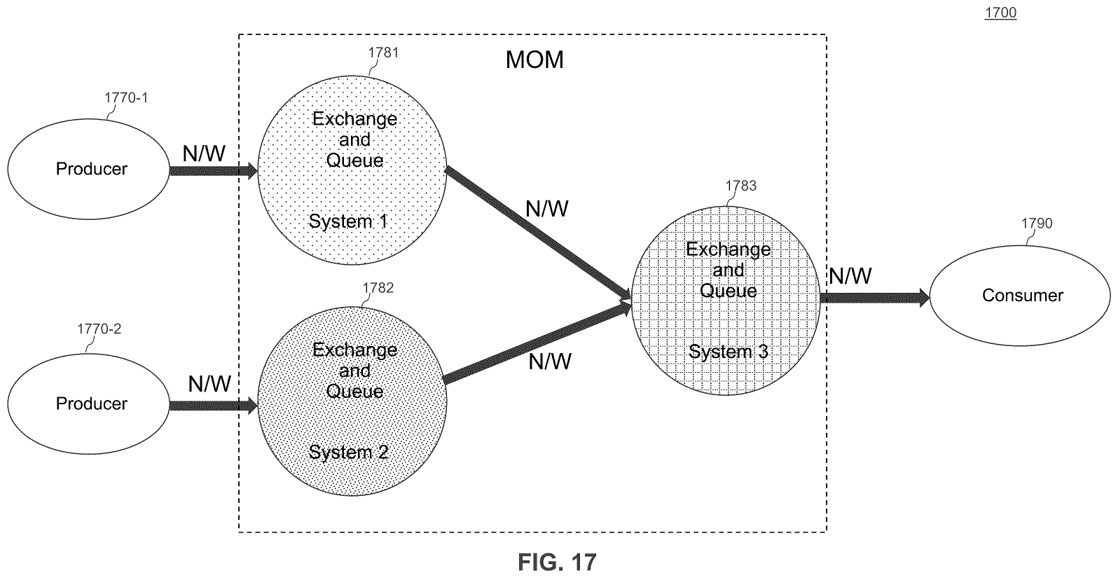

The MOM MIP 1700 in FIG. 17 is an example of a many-to-one P2P without routing MOM MIP 1700. In FIG. 17, producers 1770-1 and 1770-2 are respectively connected to messaging exchanges and queues (exchange/queue 1781 and exchange/queue 1782) of System 1 and System 2, respectively, which transmit messages to messaging exchange and queue (exchange/queue) 1783 of System 3 for consumption by a consumer 1790. The exchange/queues 1781, 1782 and 1783 are each on different servers from each other associated with different MOM platforms, so that exchange/queues 1781 and 1782 are each connected to exchange/queue 1783 via a network. The producers 1770-1 and 1770-2 are respectively connected to exchange/queue 1781 and exchange/queue 1782 via one or more networks, and exchange/queue 1783 is connected to consumer 1790 via a network. In the many-to-one topology, there are multiple producers (e.g., 1770-1 and 1770-2) using different MOM systems (e.g., System 1 and System 2) that publish to one consumer (e.g., 1790) using another MOM system (e.g., System 3).

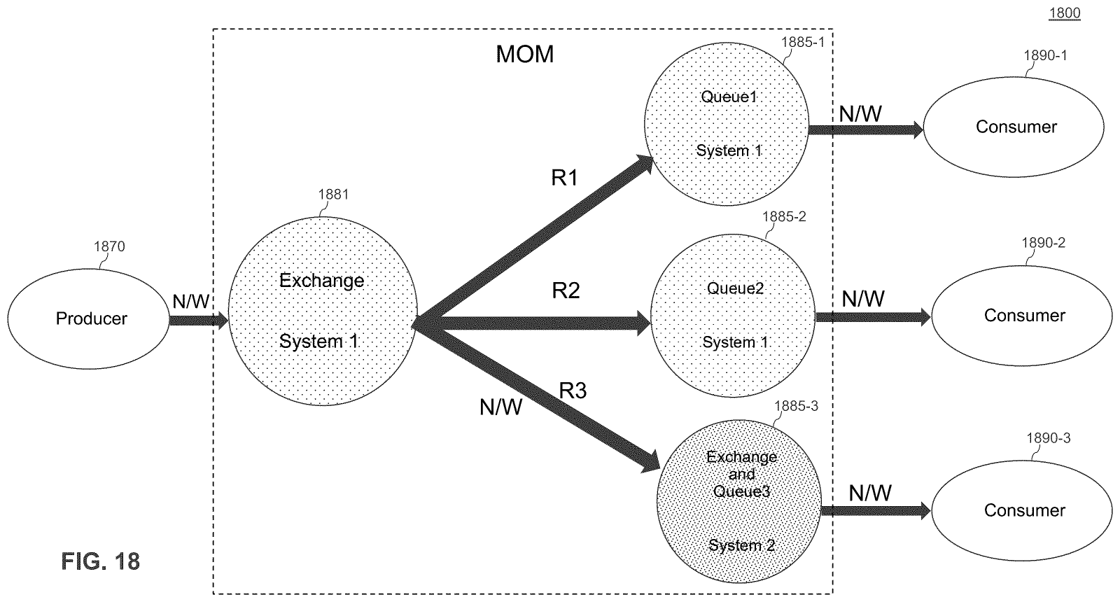

The MOM MIP 1800 in FIG. 18 is an example of a P2P with routing MOM MIP 1800. In FIG. 18, a producer 1870 is connected to an exchange 1881, which routes messages to queues 1885-1 and 1885-2 and to an exchange and queue (exchange/queue) 1885-3 for consumption by consumers 1890-1, 1890-2 and 1890-3. The queues 1885-1 and 1885-2 are connected to exchange 1881 without a network since they are on the same server. FIG. 18 indicates that exchange 1881 and queues 1885-1 and 1885-2 correspond the same MOM platform (System 1). The exchange/queue 1885-3 is on a different server associated with a different MOM platform (System 2), and is connected to the exchange 1881 via a network. The producer 1870 is connected to exchange 1881 via a network, and the queues 1885-1 and 1885-2 and exchange/queue 1885-3 are connected to consumers 1890-1, 1890-2 and 1890-3 via one or more networks.

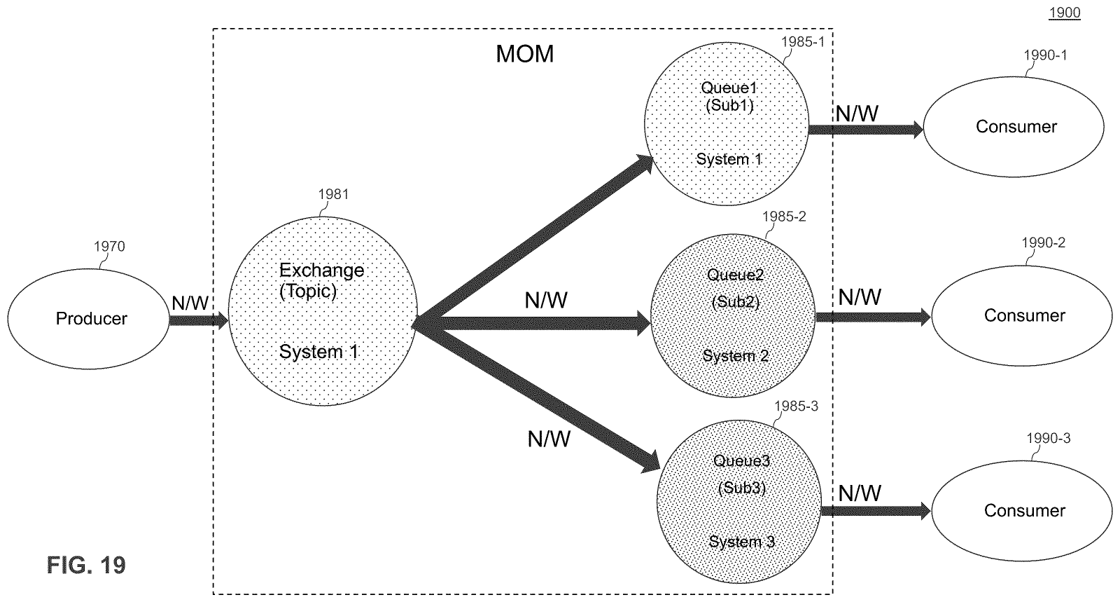

The fan-out MOM MIP 1900 in FIG. 19 is an example of a fan-out MOM MIP 1900. In FIG. 19, a producer 1970 is connected to an exchange 1981, which sends copies of the same messages to message queues 1985-1, 1985-2 and 1985-3 for consumption by consumers 1990-1, 1990-2 and 1990-3. Queue1 1985-1 is connected to exchange 1981 without a network since they are on the same server. FIG. 19 indicates that exchange 1981 and queue1 1985-1 correspond the same MOM platform (System 1). Queue1 and queue2 1985-2 and 1985-3 are on different servers associated with different MOM platforms (System 2 and System 3), and are connected to the exchange 1981 via one or more networks. The producer 1970 is connected to exchange 1981 via one or more networks, and the queues 1985-1, 1985-2 and 1985-3 are connected to consumers 1990-1, 1990-2 and 1990-3 via one or more networks. In FIG. 19, like a broadcast, each message is routed to each of the messaging queues 1985-1, 1985-2 and/or 1985-3 regardless of the topic or subscriptions Sub1, Sub2 and Sub3 of consumers 1990-1, 1990-2 and 1990-3. A fan-out methodology ignores routing keys, copies a message and routes the message to all queues regardless of consumer subscription.

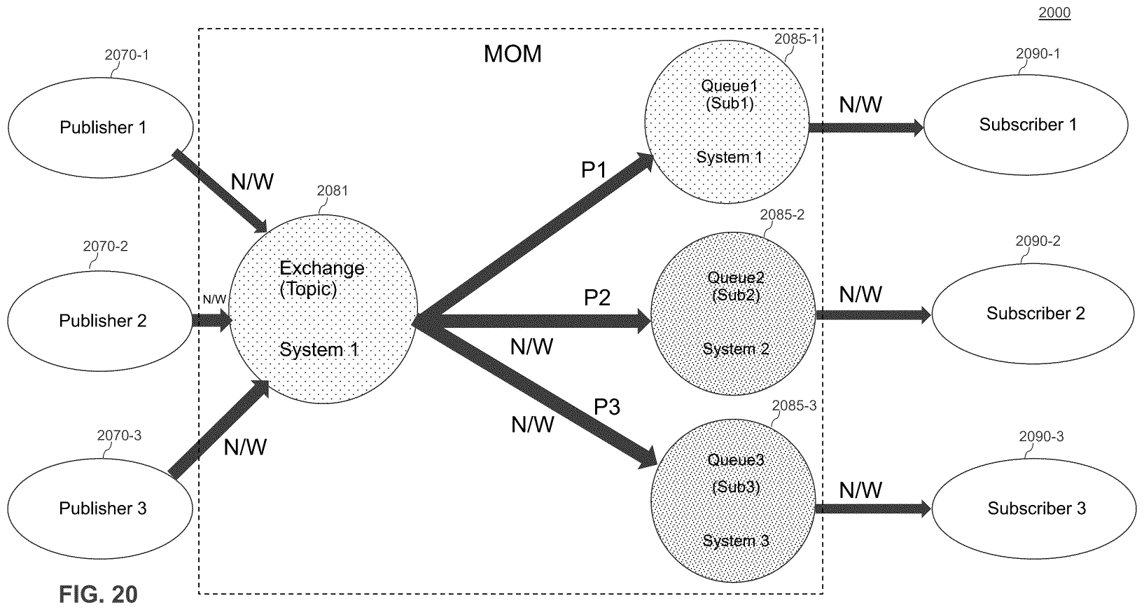

The publisher/subscriber MOM MIP 2000 in FIG. 20 is an example of a publisher/subscriber MOM MIP 2000. In FIG. 20, publishers 2070-1, 2070-2 and 2070-3 are connected to an exchange 2081, which routes messages to messaging queues 2085-1, 2085-2 and 2085-3 for consumption by subscribers 2090-1, 2090-2 and 2090-3. Queue1 2085-1 is connected to exchange 2081 without a network since they are on the same server. FIG. 20 indicates that exchange 2081 and queue1 2085-1 correspond to the same MOM platform (System 1). Queue2 and queue3 2085-2 and 2085-3 are on different servers associated with different MOM platforms (System 2 and System 3), and are connected to the exchange 2081 via one or more networks. The publishers 2070-1, 2070-2 and 2070-3 are connected to exchange 2081 via one or more networks, and the queues 2085-1, 2085-2 and 2085-3 are connected to subscribers 2090-1, 2090-2 and 2090-3 via one or more networks. The indicators P1, P2 and P3 in FIG. 20 illustrate a publisher/subscriber MOM MIP 2000, where certain messages are routed to particular messaging queues 2085-1, 2085-2 and/or 2085-3 based on subscriptions (Sub1, Sub2 and Sub3) of subscribers 2090-1, 2090-2 and 2090-3. For example, in this case, the message publishers 2070-1, 2070-2 and 2070-3 send messages to exchange 2081, which routes the messages to different queues 2085-1, 2085-2 and 2085-3 based on, for example, the topics of the messages and whether the subscribers 2090-1, 2090-2 and 2090-3 are subscribed to a particular topic.

The different servers, different MOM platforms and different message channels associated with the MIPs 1500-2000 use different protocols and interfaces. The specified properties of the MIP (step 202) include details about and parameters of the different protocols, interfaces and channels used by the different servers and different MOM platforms associated with the MIPs 1500-2000. As explained further herein, specified properties of the MIP are analyzed as features 141 by the integration service implementation engine 140 to implement integration services 142 to, for example, generate code and APIs to integrate one or more of the MIPs 1500-2000 into an integration project.

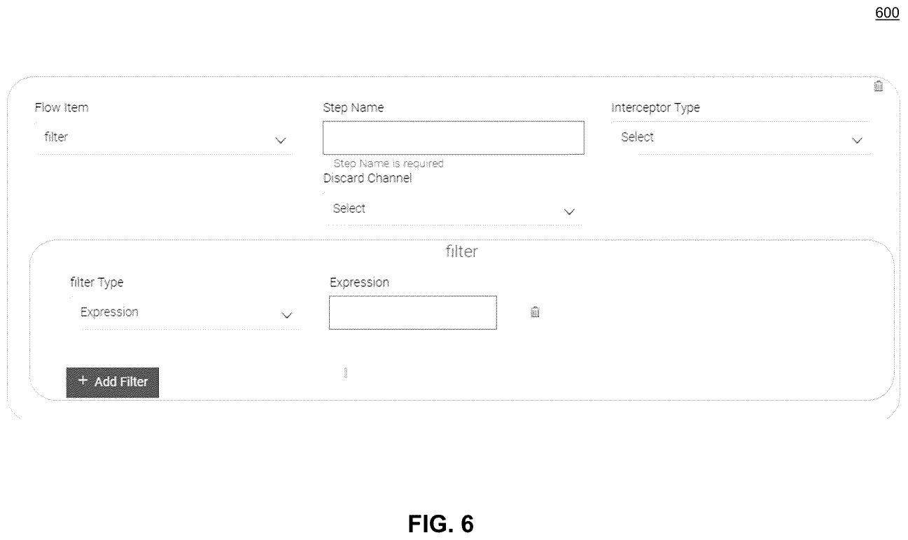

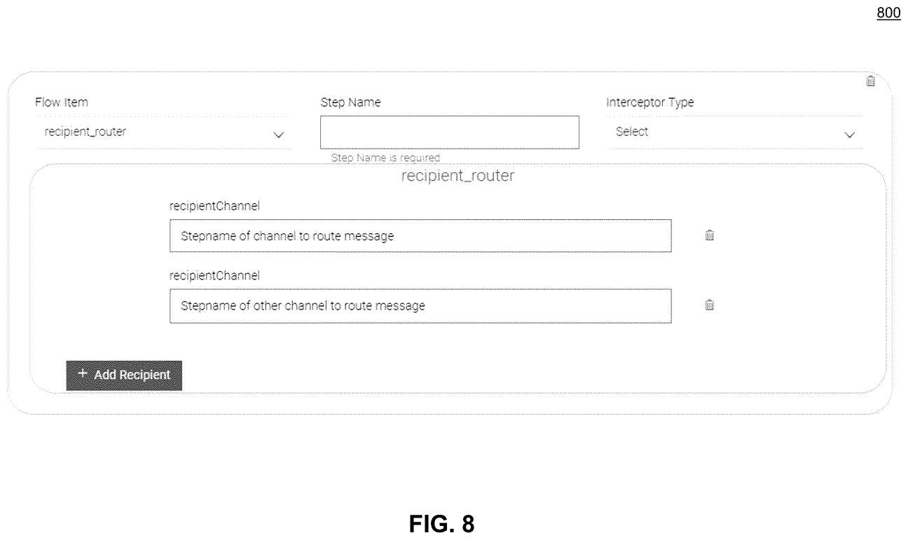

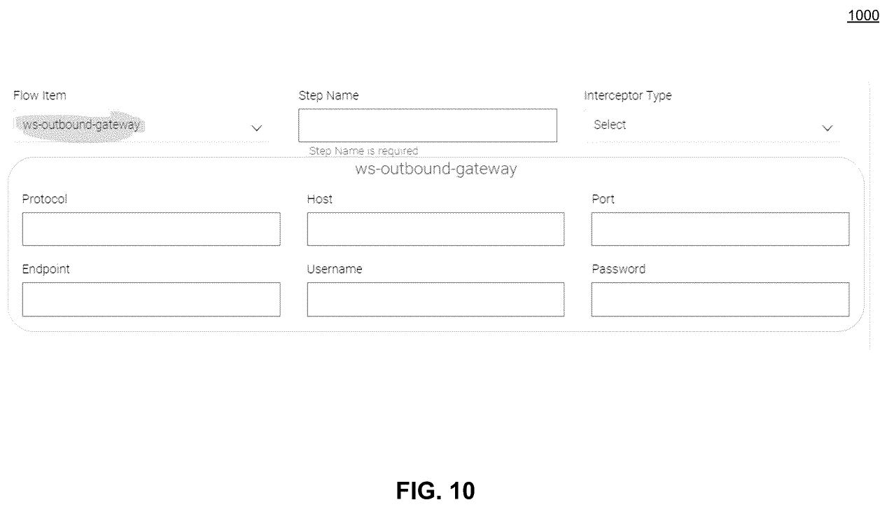

Referring back to the operational flow 200, a user specifies integration flow steps (step 203) and selects properties for the EIS messaging systems (step 204). For example, the user can use templates generated by the template and request receiving layer 121 to specify integration flow steps as well as channels, endpoints and other messaging system features described herein above. In an illustrative embodiment, FIG. 6 depicts a user interface 600 for specifying details for an EIS message filter. As can be seen, the user interface 600 includes fields for the integration flow item (filter), a step identifier (step name), whether to discard a channel, an interceptor type, a filter type and an expression. In another example, FIG. 8 illustrates a user interface 800 for inputting recipient routing details. As can be seen, the user interface 800 includes fields for the integration flow item (recipient router), a step identifier (step name), an interceptor type and specification of recipient channels to which messages can be routed. In an addition example, FIG. 10 illustrates a user interface 1000 for inputting webservice outbound gateway details. As can be seen, the user interface 1000 includes fields for the integration flow item (webservice outbound gateway), a step identifier (step name), an interceptor type and specification of webservice outbound gateway details including webservice protocol, host (e.g., host device name, IP address), port, endpoint and an access username and password.

As noted above, a user can configure an integration flow by choosing the necessary EIS messaging systems, channels, endpoints and other messaging system features. By way of illustration, examples of messaging system features include a header enricher, filters, channels, aggregators, router, recipient routers, bridges, transformers, header value routers, advanced message queuing protocol (AMQP) outbound channel adapters for use in sending messages, Java database connectivity (JDBC) outbound gateways, webservice outbound gateways, service activators and Java message service (JMS) outbound channel adapters.

At step 205, the user can utilize a template to add cloud PaaS deployment details. For example, a user can specify preferences and a configuration for a multi-cloud platform (e.g., PCF) that would be used to support development, management and delivery of software applications for an integration.

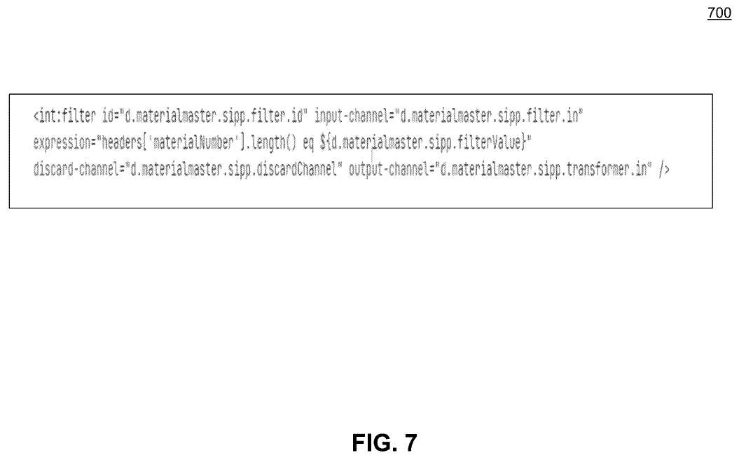

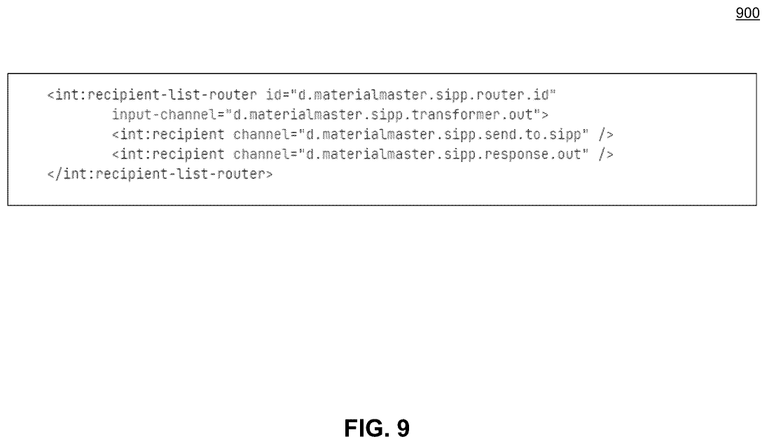

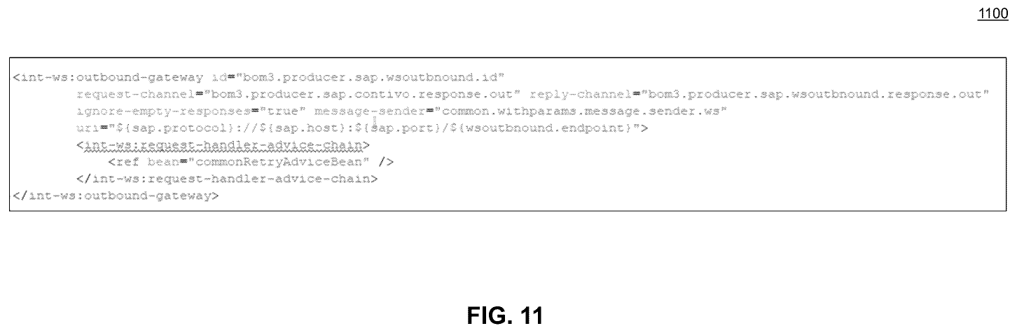

At step 206, an orchestration process is initiated, where the orchestration engine 130 initiates a workflow where the integration service implementation engine 140 analyzes the features 141 specified in the template(s) and implements integration services 142 to perform a variety of tasks for an integration project based on the features 141. For example, as noted in connection with integrating one or more of the MIPs 1500-2000 into an integration project, one or more of the integration services 142 generate code and APIs based on the features 141 specified in the templates. For example, FIG. 7 illustrates a portion of integration code 700 generated for an EIS filter based on the details for an EIS message filter specified in the user interface 600. In another example, FIG. 9 illustrates a portion of integration code 900 generated for recipient routing based on the details for recipient routing specified in the user interface 800. In addition, FIG. 11 illustrates a portion of integration code 1100 generated for a webservice outbound gateway based on the webservice outbound gateway details specified in the user interface 1000.

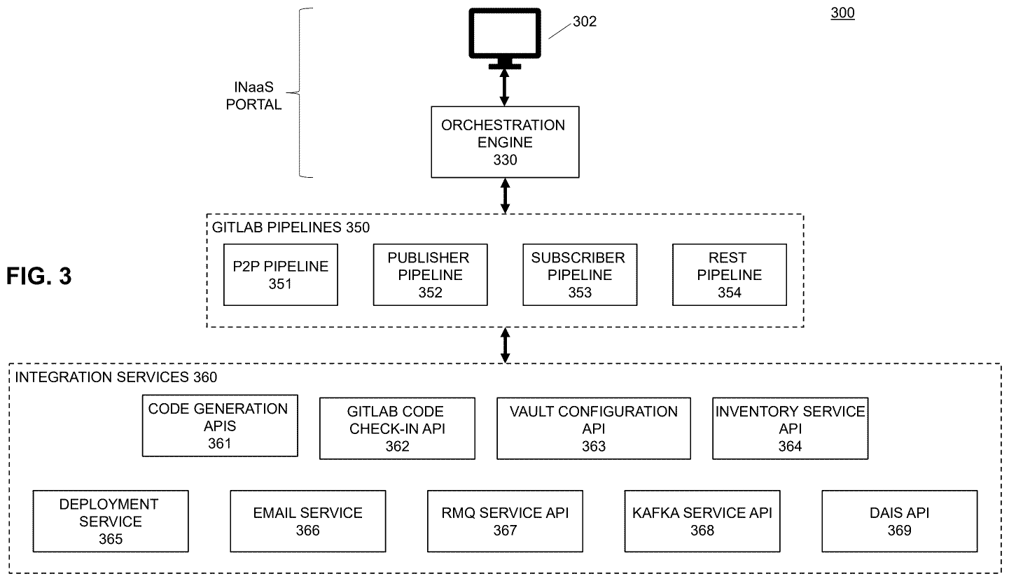

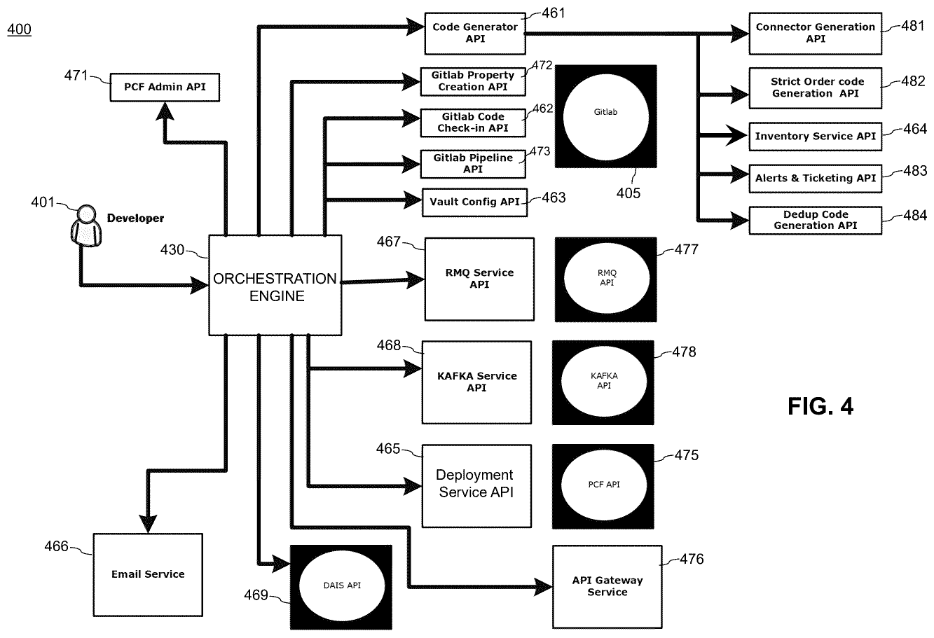

Referring to the operational architecture 300 in FIG. 3 and to the operational flow 400 in FIG. 4, a user device 302 and/or developer 401 (using, for example, a user device 102/302) provides integration project features through templates in an INaaS portal. The features are processed through the orchestration engine 330/430, which is the same or similar to the orchestration engine 130. The orchestration engine 130/330/430 manages calls for integrations from multiple users. Based on selected features (e.g., selected patterns, systems, etc.) received via the templates (e.g., user interfaces 600, 800 and 1000), the orchestration engine 130/330/430 launches appropriate workflow pipelines. A workflow pipeline is configured to launch numerous services, each of which serves a different purpose. For example, some example workflow pipelines include GitLab pipelines 350 based on selected patterns. The GitLab pipelines comprise a P2P pipeline 351, a publisher pipeline 352, a subscriber pipeline 353 and a REST pipeline 354. As can be seen in FIG. 3, the GitLab pipelines 350 launch integration services 360 including, but not necessarily limited to, code generation APIs 361, a GitLab code check-in API 362, a vault configuration API 363, an inventory service API 364, a deployment service API 365, an email service 366, an RMQ service API 367, a Kafka service API 368 and a data acquisition from industrial systems (DAIS) API 369. A code generator API 461, a GitLab code check-in API 462, a vault configuration API 463, an inventory service API 464, a deployment service API 465, an email service 466, an RMQ service API 467, a Kafka service API 468 and a DAIS API 469 respectively corresponding to the code generation APIs 361, a GitLab code check-in API 362, a vault configuration API 363, an inventory service API 364, a deployment service API 365, an email service 366, an RMQ service API 367, a Kafka service API 368 and DAIS API 369 are shown in in the operational flow 400 of FIG. 4. Additional integration services shown in FIG. 4 include a PCF admin API 471, a GitLab property creation API 472, a GitLab pipeline API 473 and an API gateway service 476. The GitLab APIs are configured to communicate with one or more instances of GitLab 405 and their corresponding APIs. Similarly, other DevOps platform APIs are configured to communicate with instances of DevOps platforms 105 and their corresponding APIs. The RMQ service API 467, Kafka service API 468 and deployment service API 465 are configured to communicate with an RMQ API 477, Kafka API 478 and a PCF API 475 (or an API of another multi-cloud platform), respectively. The DAIS API 369/469 supports real-time transfer of data from an industrial process to users or other recipients. The DAIS API 369/469 may also support discovery of parameters and updating of parameter values.

Additional integration services stemming from the code generator integration service (e.g., code generator API 461) include a connector generator API 481, a strict order code generation API 482, an alerts and ticketing API 483 and a deduplication code generation API 484. In illustrative embodiments, the pattern-based code generator integration service (e.g., code generator API 461) creates the project code based on the information entered into the templates by a user (e.g., developer 401). The generated project code is pushed to a DevOps platform 105 (e.g., Gitlab 405) by one or more DevOps APIs (e.g., the GitLab APIs noted herein above). The strict order code generation API 482 and deduplication code generation API 484 ensure efficient deduplication of messages and maintain strict message ordering from source to the target applications.

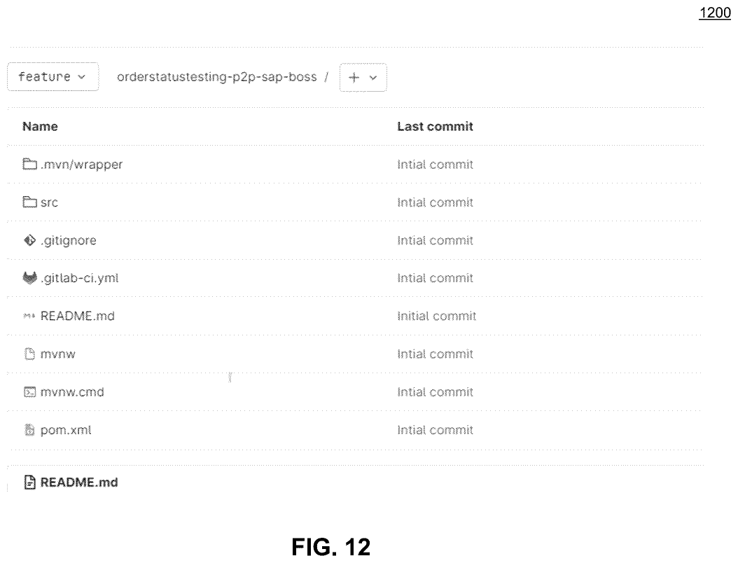

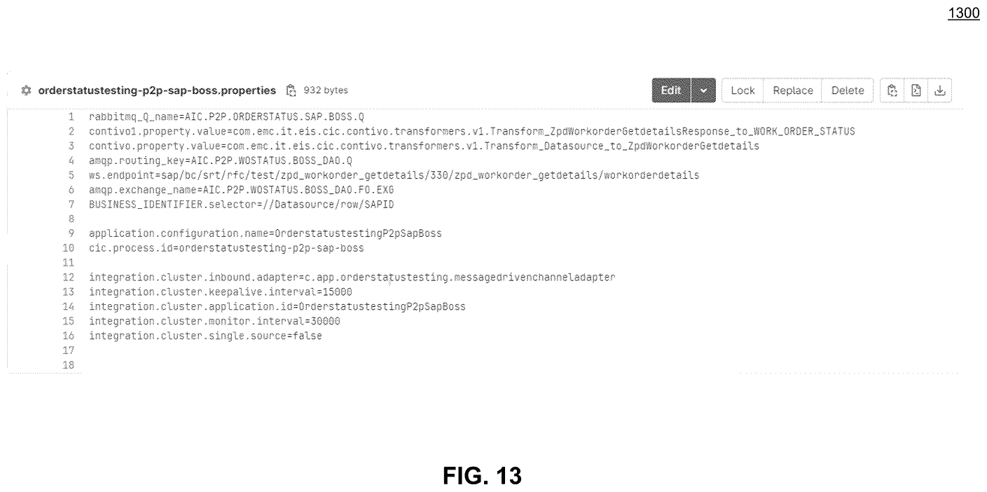

Referring to FIG. 12, once a user submits a template through a portal, and integration project code is generated, a generated project structure 1200 is pushed to a DevOps platform 105. In addition, one or more of the integration services 142 generate one or more externalized configurations based on user-inputted features. Externalized configurations enable operations with the same application code in different environments. Properties files, YAML (yet another markup language) files, environment variables and command-line arguments are used to generate the externalized configurations. The externalized configurations are pushed to a DevOps platform 105. FIG. 13 illustrates generated externalized application properties 1300 that are pushed to a DevOps platform 105.

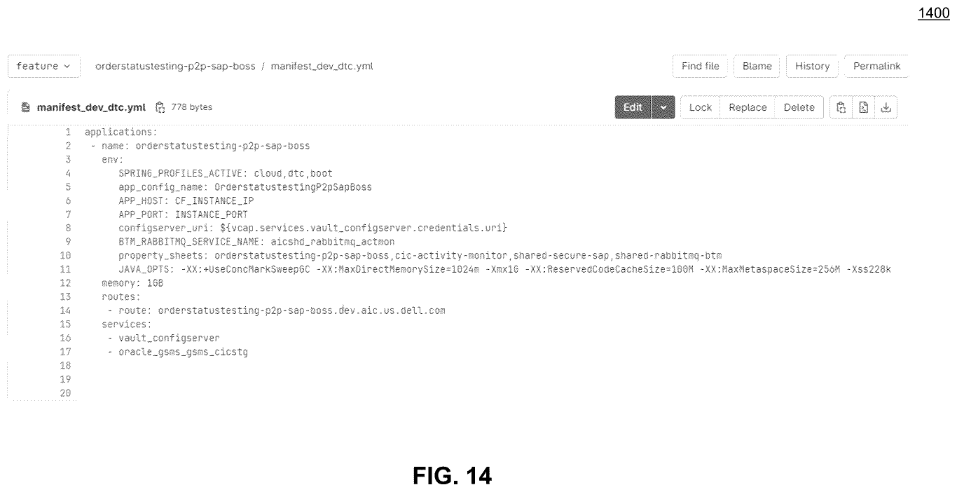

The deployment service API 365/465 generates one or more deployment manifests for a cloud PaaS (e.g., PCF) based on user-inputted features. The one or more deployment manifests are pushed to a DevOps platform 105. FIG. 14 depicts a generated deployment artifact cloud PaaS manifest 1400 that can be pushed to a DevOps platform 105. The inventory service API 364/464 generates inventory metadata for an integration based on the user-inputted features. The alerts and ticketing API 483 configures one or more transaction alerts for the integration based on the user-inputted features. Once project code is generated, the email service 366/466 generates one or more electronic messages for a user, the one or more electronic messages comprising a location of at least one DevOps platform 105.

One or more MOM service APIs generate MOM provider exchanges and queues based on the user-inputted features. For example, an RMQ service API 367/467 is used to create Rabbit MQ exchanges and queues configured in an integration project. One or more event streaming platform APIs generate MOM provider topics based on the user-inputted features. For example, a Kafka service API 368/468 creates topics configured in an integration project.

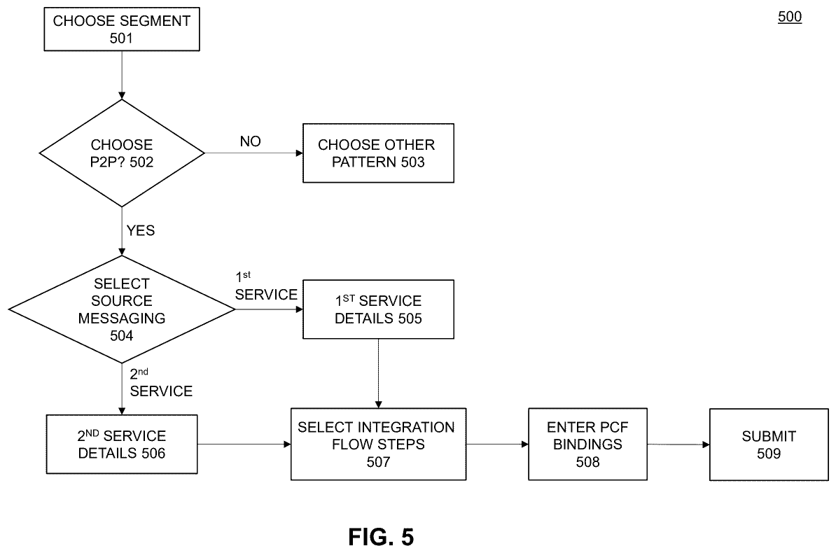

FIG. 5 depicts a process flow 500 for computing instance integration in connection with selection of a P2P pattern. At block 501, a segment is chosen. At block 502, a query is made whether a P2P pattern is chosen. If not, another MIP pattern is chosen at block 503. If yes, a query is made at block 504 asking which type of source messaging service is selected. If a first type of messaging service (e.g., RMQ) is selected at block 504, the first service details are input at block 505 and integration flow steps are selected at block 507 based on the first source messaging service details. If a second type of messaging service (e.g., IBM MQ) is selected at block 504, the second service details are input at block 506 and integration flow steps are selected at block 507 based on the second source messaging service details. At block 508, PCF bindings are entered and a computing instance integration based on a P2P pattern is submitted at block 509.

According to one or more embodiments, databases referred to herein can be configured according to a relational database management system (RDBMS) (e.g., PostgreSQL). In some embodiments, the databases referred to herein are implemented using one or more storage systems or devices associated with the integration development and deployment framework 110. In some embodiments, one or more of the storage systems utilized to implement the databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the integration development and deployment framework 110, the user interface engine 120, orchestration engine 130 and/or integration service implementation engine 140 in other embodiments can be implemented at least in part externally to the integration development and deployment framework 110, for example, as stand-alone servers, sets of servers or other types of systems coupled to the network 104. For example, the user interface engine 120, orchestration engine 130 and/or integration service implementation engine 140 may be provided as cloud services accessible by the integration development and deployment framework 110.

The user interface engine 120, orchestration engine 130 and/or integration service implementation engine 140 in the FIG. 1 embodiment are each assumed to be implemented using at least one processing device. Each such processing device generally comprises at least one processor and an associated memory, and implements one or more functional modules for controlling certain features of the user interface engine 120, orchestration engine 130 and/or integration service implementation engine 140.

At least portions of the integration development and deployment framework 110 and the elements thereof may be implemented at least in part in the form of software that is stored in memory and executed by a processor. The integration development and deployment framework 110 and the elements thereof comprise further hardware and software required for running the integration development and deployment framework 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the user interface engine 120, orchestration engine 130, integration service implementation engine 140 and other elements of the integration development and deployment framework 110 in the present embodiment are shown as part of the integration development and deployment framework 110, at least a portion of the user interface engine 120, orchestration engine 130, integration service implementation engine 140 and other elements of the integration development and deployment framework 110 in other embodiments may be implemented on one or more other processing platforms that are accessible to the integration development and deployment framework 110 over one or more networks. Such elements can each be implemented at least in part within another system element or at least in part utilizing one or more stand-alone elements coupled to the network 104.

It is assumed that the integration development and deployment framework 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the user interface engine 120, orchestration engine 130, integration service implementation engine 140 and other elements of the integration development and deployment framework 110, and the elements thereof can each be implemented in the form of one or more LXCs running on one or more VMs. Other arrangements of one or more processing devices of a processing platform can be used to implement the user interface engine 120, orchestration engine 130 and integration service implementation engine 140, as well as other elements of the integration development and deployment framework 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the integration development and deployment framework 110 to reside in different data centers. Numerous other distributed implementations of the integration development and deployment framework 110 are possible.

Accordingly, one or each of the user interface engine 120, orchestration engine 130, integration service implementation engine 140 and other elements of the integration development and deployment framework 110 can each be implemented in a distributed manner so as to comprise a plurality of distributed elements implemented on respective ones of a plurality of compute nodes of the integration development and deployment framework 110.

It is to be appreciated that these and other features of illustrative embodiments are presented by way of example only, and should not be construed as limiting in any way. Accordingly, different numbers, types and arrangements of system elements such as the user interface engine 120, orchestration engine 130, integration service implementation engine 140 and other elements of the integration development and deployment framework 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the integration development and deployment framework can be offered to cloud infrastructure customers or other users as part of FaaS, CaaS and/or PaaS offerings.

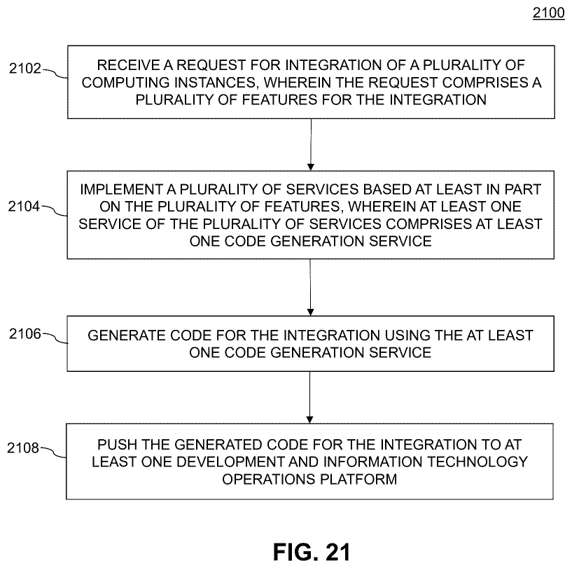

The operation of the information processing system 100 will now be described in further detail with reference to the flow diagram of FIG. 21. With reference to FIG. 21, a process 2100 for integrating computing instances as shown includes steps 2102 through 2108, and is suitable for use in the system 100 but is more generally applicable to other types of information processing systems comprising an integration development and deployment framework configured for integrating computing instances.

In step 2102, a request for integration of a plurality of computing instances is received. The request comprises a plurality of features for the integration. A portal through which at least one user can generate the request is provided, wherein the portal comprises one or more templates for the at least one user to use to specify the plurality of features. In illustrative embodiments, the plurality of features comprise one or more MOM MIPs and/or one or more EIS messaging values. The one or more MOM MIPs comprise at least one of a P2P without routing MOM MIP, a P2P without routing and with load balancing MOM MIP, a many-to-one P2P without routing MOM MIP, a P2P with routing MOM MIP, a fan-out MOM MIP and a publisher/subscriber MOM MIP.

In step 2104, a plurality of services are implemented based at least in part on the plurality of features, wherein at least one service of the plurality of services comprises at least one code generation service. The plurality of services may respectively comprise at least one API.

In step 2106, code for the integration is generated using the at least one code generation service. In step 2108, the generated code for the integration is pushed to at least one DevOps platform.

In illustrative embodiments, at least one other service of the plurality of services generates one or more externalized configurations based at least in part on one or more of the plurality of features, the one or more externalized configurations are pushed to the at least one DevOps platform. In illustrative embodiments, at least one other service of the plurality of services generates one or more deployment manifests for a cloud PaaS based at least in part on one or more of the plurality of features, and the one or more deployment manifests are pushed to the at least one DevOps platform.

In illustrative embodiments, at least one other service of the plurality of services generates inventory metadata for the integration based at least in part on one or more of the plurality of features, and at least one other service of the plurality of services configures one or more transaction alerts for the integration based at least in part on one or more of the plurality of features.

In illustrative embodiments, at least one other service of the plurality of services generates one or more electronic messages comprising a location of the at least one DevOps platform. At least one other service of the plurality of services generates one or more MOM provider exchanges and queues based at least in part on one or more of the plurality of features. At least one other service of the plurality of services generates one or more MOM provider topics based at least in part on one or more of the plurality of features.

The plurality of computing instances may comprise at least one of a plurality of applications, a plurality of microservices, a plurality of platforms, a plurality of databases and a plurality of devices.

It is to be appreciated that the FIG. 21 process and other features and functionality described above can be adapted for use with other types of information systems configured to execute computing instance integration services in an integration development and deployment framework or other type of platform.

The particular processing operations and other system functionality described in conjunction with the flow diagram of FIG. 21 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 21 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with an integration development and deployment framework as disclosed herein can provide a number of significant advantages relative to conventional arrangements. For example, the integration development and deployment framework ensures efficient deduplication of messages and maintains strict message ordering from source to the target applications, addressing limitations found in conventional approaches. As an additional advantage, the integration development and deployment framework generates end-to-end (E2E) middleware application cloud (MAC) integration project code and essential artifacts, streamlining the development to deployment process. Unlike conventional approaches, the illustrative embodiment provides technical solutions which auto-generate complete project code and artifacts for enterprise integration pattern (EIP) flow, specifically down to the queue level details, including the queue objects needed to communicate between source and target applications.

Further, the embodiments advantageously provide a form-based cloud-native integration development and deployment solution that significantly reduces developer efforts with respect to current approaches. By enabling users to enter integration flow details, the integration development and deployment framework automatically converts the entered features into MAC framework-based microservices code and automatically checks in to a DevOps repository. In addition to code generation, the integration development and deployment framework generates deployment configurations, inventory metadata, alerts and incident configurations, simplifying the process from development to deployment. Leveraging the integration development and deployment framework produces cleaner and more easily maintainable code than conventional approaches. Furthermore, the integration development and deployment framework allows users to enhance generated code, offering flexibility and efficiency in the integration process.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the integration development and deployment framework 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and an integration development and deployment framework in illustrative embodiments. These and other cloud-based systems in illustrative embodiments can include object stores.

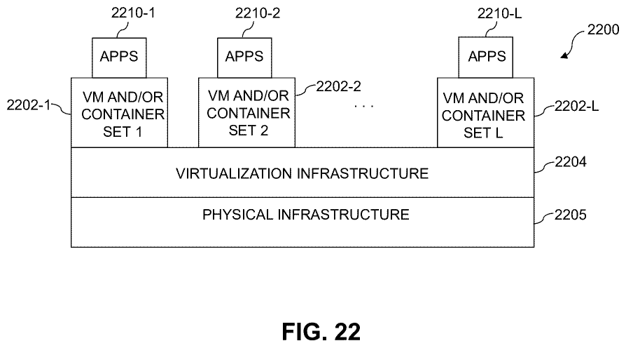

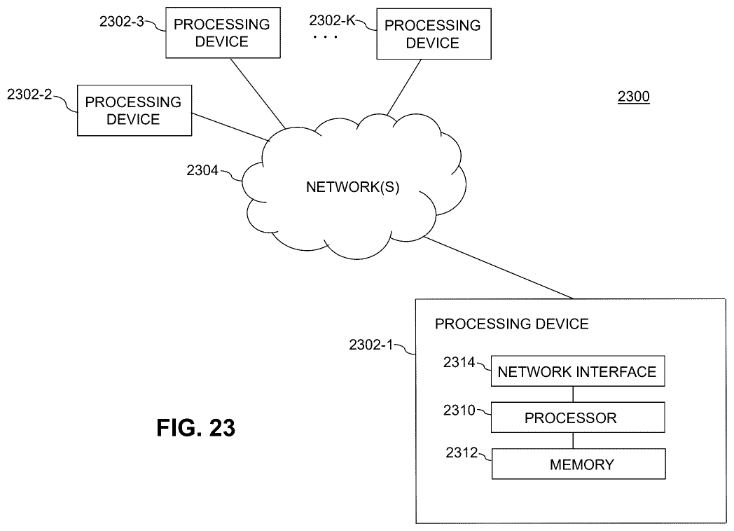

Illustrative embodiments of processing platforms will now be described in greater detail with reference to FIGS. 22 and 23. Although described in the context of system 100, these platforms may also be used to implement at least portions of other information processing systems in other embodiments.

FIG. 22 shows an example processing platform comprising cloud infrastructure 2200. The cloud infrastructure 2200 comprises a combination of physical and virtual processing resources that may be utilized to implement at least a portion of the information processing system 100. The cloud infrastructure 2200 comprises multiple virtual machines (VMs) and/or container sets 2202-1, 2202-2, . . . 2202-L implemented using virtualization infrastructure 2204. The virtualization infrastructure 2204 runs on physical infrastructure 2205, and illustratively comprises one or more hypervisors and/or operating system level virtualization infrastructure. The operating system level virtualization infrastructure illustratively comprises kernel control groups of a Linux operating system or other type of operating system.

The cloud infrastructure 2200 further comprises sets of applications 2210-1, 2210-2, . . . 2210-L running on respective ones of the VMs/container sets 2202-1, 2202-2, . . . 2202-L under the control of the virtualization infrastructure 2204. The VMs/container sets 2202 may comprise respective VMs, respective sets of one or more containers, or respective sets of one or more containers running in VMs.

In some implementations of the FIG. 22 embodiment, the VMs/container sets 2202 comprise respective VMs implemented using virtualization infrastructure 2204 that comprises at least one hypervisor. A hypervisor platform may be used to implement a hypervisor within the virtualization infrastructure 2204, where the hypervisor platform has an associated virtual infrastructure management system. The underlying physical machines may comprise one or more distributed processing platforms that include one or more storage systems.

In other implementations of the FIG. 22 embodiment, the VMs/container sets 2202 comprise respective containers implemented using virtualization infrastructure 2204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 2200 shown in FIG. 22 may represent at least a portion of one processing platform. Another example of such a processing platform is processing platform 2300 shown in FIG. 23.

The processing platform 2300 in this embodiment comprises a portion of system 100 and includes a plurality of processing devices, denoted 2302-1, 2302-2, 2302-3, . . . 2302-K, which communicate with one another over a network 2304.

The network 2304 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2302-1 in the processing platform 2300 comprises a processor 2310 coupled to a memory 2312. The processor 2310 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 2312 may comprise random access memory (RAM), read-only memory (ROM), flash memory or other types of memory, in any combination. The memory 2312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2302-1 is network interface circuitry 2314, which is used to interface the processing device with the network 2304 and other system components, and may comprise conventional transceivers.

The other processing devices 2302 of the processing platform 2300 are assumed to be configured in a manner similar to that shown for processing device 2302-1 in the figure.

Again, the particular processing platform 2300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the integration development and deployment framework 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and integration development and deployment frameworks. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
receiving a request for integration of a plurality of computing instances, wherein the request comprises a plurality of features for the integration;
implementing a plurality of services based at least in part on the plurality of features, wherein at least one service of the plurality of services comprises at least one code generation service;
generating code for the integration using the at least one code generation service; and
pushing the generated code for the integration to at least one development and information technology operations platform;
wherein the steps of the method are executed by a processing device operatively coupled to a memory.

2. The method of claim 1, further comprising providing a portal through which at least one user can generate the request, wherein the portal comprises one or more templates for the at least one user to use to specify the plurality of features.

3. The method of claim 1, wherein the plurality of features comprise one or more message-oriented-middleware messaging integration patterns.

4. The method of claim 3, wherein the one or more message-oriented-middleware messaging integration patterns comprise at least one of a point-to-point without routing message-oriented-middleware messaging integration pattern, a point-to-point without routing and with load balancing message-oriented-middleware messaging integration pattern, a many-to-one point-to-point without routing message-oriented-middleware messaging integration pattern, a point-to-point with routing message-oriented-middleware messaging integration pattern, a fan-out message-oriented-middleware messaging integration pattern and a publisher/subscriber message-oriented-middleware messaging integration pattern.

5. The method of claim 1, wherein:
at least one other service of the plurality of services generates one or more externalized configurations based at least in part on one or more of the plurality of features; and
the method further comprises pushing the one or more externalized configurations to the at least one development and information technology operations platform.

6. The method of claim 1, wherein:
at least one other service of the plurality of services generates one or more deployment manifests for a cloud platform as a service based at least in part on one or more of the plurality of features; and
the method further comprises pushing the one or more deployment manifests to the at least one development and information technology operations platform.

7. The method of claim 1, wherein at least one other service of the plurality of services generates inventory metadata for the integration based at least in part on one or more of the plurality of features.

8. The method of claim 1, wherein at least one other service of the plurality of services configures one or more transaction alerts for the integration based at least in part on one or more of the plurality of features.

9. The method of claim 1, wherein at least one other service of the plurality of services generates one or more electronic messages comprising a location of the at least one development and information technology operations platform.

10. The method of claim 1, wherein at least one other service of the plurality of services generates one or more message-oriented-middleware provider exchanges and queues based at least in part on one or more of the plurality of features.

11. The method of claim 1, wherein at least one other service of the plurality of services generates one or more message-oriented-middleware provider topics based at least in part on one or more of the plurality of features.

12. The method of claim 1, wherein the plurality of services respectively comprise at least one application programming interface.

13. The method of claim 1, wherein the plurality of features comprise one or more enterprise integration services messaging values.

14. The method of claim 1, wherein the plurality of computing instances comprise at least one of a plurality of applications, a plurality of microservices, a plurality of platforms, a plurality of databases and a plurality of devices.

15. An apparatus comprising:
a processing device operatively coupled to a memory and configured to:
receive a request for integration of a plurality of computing instances, wherein the request comprises a plurality of features for the integration;
implement a plurality of services based at least in part on the plurality of features, wherein at least one service of the plurality of services comprises at least one code generation service;
generate code for the integration using the at least one code generation service; and
push the generated code for the integration to at least one development and information technology operations platform.

16. The apparatus of claim 15, wherein:
at least one other service of the plurality of services generates one or more deployment manifests for a cloud platform as a service based at least in part on one or more of the plurality of features; and
the processing device is further configured to push the one or more deployment manifests to the at least one development and information technology operations platform.

17. The apparatus of claim 15, wherein at least one other service of the plurality of services generates one or more message-oriented-middleware provider exchanges and queues based at least in part on one or more of the plurality of features.

18. An article of manufacture comprising a non-transitory processor-readable storage medium having stored therein program code of one or more software programs, wherein the program code when executed by at least one processing device causes said at least one processing device to perform the steps of:
receiving a request for integration of a plurality of computing instances, wherein the request comprises a plurality of features for the integration;
implementing a plurality of services based at least in part on the plurality of features, wherein at least one service of the plurality of services comprises at least one code generation service;
generating code for the integration using the at least one code generation service; and
pushing the generated code for the integration to at least one development and information technology operations platform.

19. The article of manufacture of claim 18, wherein:
at least one other service of the plurality of services generates one or more deployment manifests for a cloud platform as a service based at least in part on one or more of the plurality of features; and
the program code causes said at least one processing device to further perform the step of pushing the one or more deployment manifests to the at least one development and information technology operations platform.

20. The article of manufacture of claim 18, wherein at least one other service of the plurality of services generates one or more message-oriented-middleware provider exchanges and queues based at least in part on one or more of the plurality of features.
